(19) United States
(12) Patent Application Publication
(10) Pub. No.: US 2017/0168766 A1
(43) Pub. Date: Jun. 15, 2017

(54) CONTENT DISPLAYING METHOD AND DEVICE

(71) Applicant: Beijing Zhigu Rui Tuo Tech Co., Ltd, Beijing (CN)

(72) Inventors: Jia LIU, Beijing (CN); Wei SHI, Beijing (CN); Hongjiang ZHANG, Beijing (CN)

(21) Appl. No.: 15/115,663

(22) PCT Filed: Jan. 15, 2015
(86) PCT No.: PCT/CN2015/070757

§ 371 Date: Jul. 29, 2016

(30) Foreign Application Priority Data
Feb. 28, 2014 (CN) 2014100717122

(51) Int. Cl. G06F 3/14

(52) U.S. Cl. CPC G06F 3/14; H04W 84/12

(57) ABSTRACT

A content displaying method and device are provided. A method comprises: receiving, by a display device, a content display request from a request device; obtaining to-be-displayed content according to the content display request; and displaying the to-be-displayed content in response to a first signal is detected. A display solution provides a user with choices and convenient display triggering approaches of the display device through the first signal.

### RELATED APPLICATION

The present international patent cooperative treaty (PCT) application claims the benefit of priority to Chinese Patent Application No. 201410071712.2, filed on Feb. 28, 2014, and entitled “Content Displaying Method and Device”, which is hereby incorporated into the present international PCT application by reference herein in its entirety.

### TECHNICAL FIELD

Embodiments of the present application relate to the field of inter-device interaction technologies, and particularly, relate to a content displaying method and device.

### BACKGROUND

With continuous advances of technologies, wearable technologies have been gradually entering people's daily life. Wearable devices, comprising smart watches, smart glasses, and smart earrings further widen human-machine interaction approaches, to cause that the connections between people and the outside world become freer, smoother, and more convenient. As can be predicted, users will not only have conventional mobile devices such as notebook computers, smart phones, and tablet computers, but also wear and use various wearable devices. The two types of devices each have advantages in aspects of portability, ease to use, and processing capability and can be used in different scenarios to meet specific requirements. Also, these devices generally support various wireless communication technologies, such as the data cellular network, Wi-Fi, Bluetooth, and infrared and so on. The device-to-device connection and coordination may also become extremely convenient.

Due to restrictions for some wearable devices in aspects such as energy capacity of battery, computing performance, storage capacity, and display capability, not all content is suitable to be displayed on the wearable devices. For example, when a mobile phone receives a picture or a video, a smart watch connected to the mobile phone informs a user of the message and displays a thumbnail of the picture or a screenshot of the video. The user receives the notification and wants to view the specific content, but the smart watch is not suitable to display the specific content due to restraints such as the screen size, resolution, and power consumption of the smart watch.

### SUMMARY

An example objective of embodiments of the present application is to provide a display solution.

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the purpose of this summary is to present some concepts related to some exemplary non-limiting embodiments in simplified form as a prelude to more detailed descriptions of the various embodiments that follow in the disclosure.

According to one example aspect of the embodiments of the present application, a content displaying method is provided, comprising:

receiving, by a display device, a content display request from a request device;

obtaining to-be-displayed content according to the content display request; and

displaying the to-be-displayed content in response to a first signal is detected.

According to another example aspect of the embodiments of the present application, a content displaying method is provided, comprising:

sending, by a request device, a content display request of to-be-displayed content to a display device; and

sending a display instruction to the display device in response to a first signal is detected, wherein the display instruction is used for instructing the display device to display the to-be-displayed content.

According to another example aspect of the embodiments of the present application, a display device is provided, comprising:

a receiving module, configured to receive a content display request from a request device;

an obtaining module, configured to obtain to-be-displayed content according to the content display request; and

a display module, configured to display the to-be-displayed content in response to a first signal is detected.

According to another example aspect of the embodiments of the present application, a request device is provided, comprising:

a first sending module, configured to send a content display request of to-be-displayed content to a display device; and

a second sending module, configured to send a display instruction to the display device in response to a first signal is detected, wherein the display instruction is used for instructing the display device to display the to-be-displayed content.

At least one of the aforementioned multiple technical solutions has the following example non-limiting beneficial effects:

Embodiments of the present application provide a display solution through that the display device receives a content display request from the request device, obtains to-be-displayed content according to the content display request, and displays the to-be-displayed content in response to a first signal is detected, and provide a user with choices and convenient display triggering approaches of the display device through the first signal.

### BRIEF DESCRIPTION OF THE DRAWINGS

FIG. 1 is an example flowchart of a first embodiment of a content displaying method provided in the present application;

FIG. 2 is an example flowchart of a second embodiment of a content displaying method provided in the present application;

FIG. 3a is an example structural diagram of a first embodiment of a display device provided in the present application;

FIG. 3b is an example structural diagram of an embodiment shown in FIG. 3 a;

FIG. 4 is an example structural diagram of a first embodiment of a request device provided in the present application;

FIG. 5 is an example structural diagram of a second embodiment of a display device provided in the present application; and

FIG. 6 is an example structural diagram of a second embodiment of a request device provided in the present application.

### DETAILED DESCRIPTION

The following further describes, in detail, the detailed description of the present application with reference to accompanying drawings and embodiments. The embodiments below are for illustration of the present application only, but are not limitative of the disclosure of the present application.

Persons skilled in the art could understand that a “display device” in the present application can generally be understood as any device capable of displaying, comprising but not limited to: a wearable device, a mobile phone, a personal digital assistant (PDA), a tablet computer, a smart television set, and the like.

Persons skilled in the art could understand that a “request device” in the present application can generally be understood as any device, comprising but not limited to: a wearable device, a mobile phone, a PDA, a tablet computer, a smart television set, and the like.

FIG. 1 is a flowchart of Embodiment 1 of a content displaying method provided in the present application. As shown in FIG. 1, this embodiment comprises:

101: A display device receives a content display request from a request device.

Optionally, the content display request comprises: an identifier and/or address of to-be-displayed content. Herein, the identifier of the to-be-displayed content may comprise a file name of the to-be-displayed content, or, comprise at least one keyword, a data size, or the like of the to-be-displayed content. The address of the to-be-displayed content is a storage path of the to-be-displayed content in the display device, or, a storage path of the to-be-displayed content in another device and an identifier of the another device, or, a website address.

Optionally, the receiving, by a display device, a content display request from a request device comprises:

receiving, by the display device, the content display request from the request device based on a first communication technology.

Herein, the first communication technology may be Bluetooth, WiFi, or Zigbee. Further, the first communication technology may be Bluetooth low energy (BLE).

102: Obtain to-be-displayed content according to the content display request.

Specifically, the to-be-displayed content comprises but not limited to at least one of the followings: a picture, a video, a text message, and the like.

In an optional embodiment, the obtaining to-be-displayed content according to the content display request comprises:

obtaining a part or the whole of the to-be-displayed content from the display device locally or externally according to the content display request.

For example, if the to-be-displayed content is stored in the display device, the content display request may only comprise an identifier of the to-be-displayed content; or, the content display request may only comprise a storage path of the to-be-displayed content in the display device; or, the content display request may comprise an identifier of the to-be-displayed content and a storage path of the to-be-displayed content in the display device, and accordingly, the display device obtains a part or the whole of the to-be-displayed content locally. If the to-be-displayed content is stored in another device, the content display request may only comprise an identifier of the to-be-displayed content, and accordingly, the display device searches, in a local area network or through a search engine, for and obtains the to-be-displayed content from another device; or, the content display request may comprise an address of the to-be-displayed content, and accordingly, the display device obtains a part or the whole of the to-be-displayed content from the another device according to the address of the to-be-displayed content.

Generally, if the data size of the to-be-displayed content is small, the whole of the to-be-displayed content may be obtained directly. If the data size of the to-be-displayed content is large, a part of the to-be-displayed content may be obtained first and further, the other part of the to-be-displayed content may be obtained during a display process.

In another optional embodiment, the content display request further comprises: a part or the whole of the to-be-displayed content.

Optionally, the obtaining to-be-displayed content according to the content display request comprises:

obtaining a part or the whole of the to-be-displayed content from the content display request.

For example, if the content display request comprises the whole of the to-be-displayed content, the display device obtains the whole of the to-be-displayed content from the content display request, or, first obtains a part of the to-be-displayed content from the content display request and then obtains the other part of the to-be-displayed content from the content display request during a display process. If the content display request comprises a part of the to-be-displayed content and an address of the to-be-displayed content, the display device obtains the part of the to-be-displayed content from the content display request and then obtains the other part of the to-be-displayed content according to the address of the to-be-displayed content during a display process.

103: Display the to-be-displayed content in response to a first signal is detected.

In an optional embodiment, the display device displays the to-be-displayed content as long as the first signal is detected. That is, detecting a first signal is a unique condition for displaying the to-be-displayed content.

In another optional embodiment, the displaying the to-be-displayed content comprises:

displaying the to-be-displayed content according to a display instruction from the request device and based on a second communication technology.

Herein, when the display instruction is obtained by the display device is not limited in this embodiment. Optionally, the display device receives the display instruction before the first signal is detected, and accordingly, the to-be-displayed content is not immediately displayed after the display instruction is received, but rather that the to-be-displayed content is displayed after the first signal is detected. Optionally, the display device receives the display instruction at the same time when the first signal is detected, and accordingly, the display device displays the to-be-displayed content after simultaneously detecting the first signal and receiving the display instruction. Optionally, the display device receives the display instruction after the first signal is detected, and accordingly, the display device does not immediately display the to-be-displayed content after the first signal is detected, but rather displays the to-be-displayed content after the display instruction is received.

In any one of the embodiments, the first signal may be a signal of any type, such as, a signal based on a certain communication technology or a magnetic signal.

Optionally, the first signal is a signal from the request device based on a third communication technology.

Herein, one possible scenario is described as: the third communication technology is different from the first communication technology. For example, the display device receives, based on a communication technology, the content display request sent by the request device and displays the to-be-displayed content upon detecting of a signal transmitted by the request device and based on another communication technology.

In this scenario, the display device may perform displaying without the display instruction, or may also perform displaying according to the display instruction. Further, the third communication technology may be the same as or different from the second communication technology. The first communication technology may be the same as or different from the second communication technology.

Another possible scenario is described as: the third communication technology is the same as the second communication technology. For example, the display device displays the to-be-displayed content when two conditions, namely, a display instruction sent by the request device is received based on a communication technology and a signal transmitted by the request device and based on the communication technology is detected, are both met. In this scenario, the first communication technology may be the same as or different from the second communication technology.

Another possible scenario is described as: the third communication technology is different from the second communication technology. For example, the display device displays the to-be-displayed content when two conditions, namely, a display instruction sent by the request device is received based on a communication technology and a signal transmitted by the request device and based on another communication technology is detected, are both met. In this scenario, the first communication technology may be the same as or different from the second communication technology. The first communication technology may be the same as or different from the third communication technology.

Optionally, the third communication technology is near field communication (NFC).

Optionally, the first signal is a magnetic signal. Generally, a magnetic signal is a signal sent by a magnet. The magnet may be disposed in the request device or another device.

Herein, one possible scenario is described as: the second communication technology is the same as the first communication technology. For example, the display device receives, based on a communication technology, the content display request sent by the request device and displays the to-be-displayed content in a case where two conditions, namely, a magnetic signal sent by the request device or another device is detected and a display instruction sent by the request device is received based on the communication technology, are both met.

Another possible scenario is described as: the second communication technology is different from the first communication technology. For example, the display device receives, based on a communication technology, the content display request sent by the request device and displays the to-be-displayed content in a case where two conditions, namely, a magnetic signal sent by the request device or another device is detected and a display instruction sent by the request device is received based on another communication technology, are both met.

In any one of the embodiments or scenarios, optionally, a user may further be requested for a confirmation before the displaying. Specifically, the displaying the to-be-displayed content in response to a detected first signal comprises:

prompting a user in response to the first signal is detected; and

displaying the to-be-displayed content according to a display confirmation from the user.

Herein, there are multiple methods for prompting the user. For example, a window is presented on a display interface of the display device, a user is requested to determine whether to perform displaying, and when the user clicks a “confirm” button in the window, the display device receives a display confirmation from the user and then performs displaying.

Optionally, if the display confirmation from the user is not received after the user is prompted, the to-be-displayed content is not displayed.

Optionally, in an embodiment in which a display instruction is needed, the display device prompts a user and displays the to-be-displayed content according to a display confirmation from the user when two conditions, namely, the display instruction is received and the first signal is detected, are both met.

In any one of the optional embodiments or scenarios, optionally, the content display request further comprises: a display type. The display type comprises at least one of the following: opening, playing, zooming in, and full screen. The displaying the to-be-displayed content comprises:

displaying the to-be-displayed content according to the display type.

Specifically, the corresponding display type may be slightly disparate for different to-be-displayed content. For example, when the to-be-displayed content is a picture: if the display type is opening, the display device selects software capable of opening the picture to open the picture; if the display type is zooming in, the display device zooms in the picture according to a preset multiple on the basis of the opening the picture; and if the display type is full screen, the display device displays the picture in full screen on the basis of the opening the picture. When the to-be-displayed content is a video: if the display type is opening, the display device selects software capable of opening the video to open the video, but does not play it, and at this time, what is displayed may be an image of the video; if the display type is playing, the display device selects software capable of playing the video to play the video; and if the display type comprises playing and full screen, the display device selects software capable of playing the video to play the video in full screen.

In any one of the embodiments or scenarios, optionally, after the displaying the to-be-displayed content, the method further comprises:

returning a display success message to the request device.

In a possible scenario, the distance between the display device and the request device is a first distance when the display device receives the content display request from the request device. The distance between the display device and the request device is a second distance when the display device detects the first signal. Optionally, the first distance is greater than the second distance.

Specifically, the display device and/or the request device is/are (a) mobile device(s). During the device(s)'s moving process, the distance between the display device and the request device changes. Optionally, the distance is diminishing. Further, if the first distance is greater than the second distance: before a display condition is met, that is, when the display device does not detect the first signal, the display device has received the content display request and obtained a part or the whole of the to-be-displayed content, and when the display condition is met, the display device can implement rapid displaying on the basis of the obtained part or whole of the to-be-displayed content.

For example, when a mobile phone receives a picture, a smart watch which is connected to the mobile phone and equipped on a wrist of a user informs the user of the message and displays a thumbnail of the picture. Also, the smart watch acts as a request device and broadcasts a content display request through a BLE link under an instruction of the user or automatically. Multiple display devices, such as a mobile phone, a PAD, and a smart television set, within a broadcasting range of the smart watch all receive the content display request so as to obtain the picture. If the user wants to view specific content on the PAD, the user may go to pick up the PAD. During the user's moving process, the distance between the smart watch and the PAD is also continuously diminishing. When the distance between the smart watch and the PAD reaches a certain distance (for example, 0.2 m), the PAD detects a signal based on NFC sent by the smart watch and the PAD displays the picture. Or, if the user wants to view specific content on the PAD, the user may pick up a controller provided with a magnet to approach the PAD. During the user's moving process, the distance between the controller and the PAD is accordingly continuously diminishing. When the distance between the controller and the PAD reaches a certain distance (for example, 0.2 m), the PAD detects a magnetic signal sent by the controller and the PAD displays the picture.

This embodiment provides a display solution through that the display device receives a content display request from the request device, obtains to-be-displayed content according to the content display request, and displays the to-be-displayed content in response to a detected first signal, and provides a user with choices and a convenient display triggering approach of the display device through the first signal.

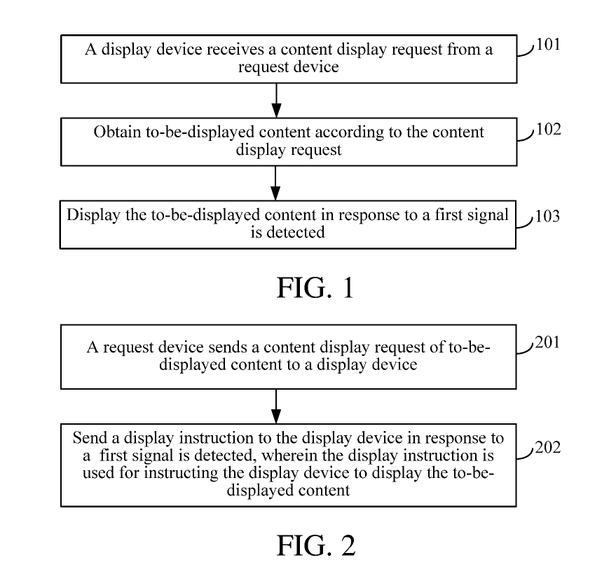

FIG. 2 is a flowchart of Embodiment 2 of a content displaying method provided in the present application. As shown in FIG. 2, this embodiment comprises:

201: A request device sends a content display request of to-be-displayed content to a display device.

Specifically, the to-be-displayed content comprises but not limited to at least one of the followings: a picture, a video, a text message, and the like.

Optionally, the content display request comprises: an identifier and/or address of the to-be-displayed content. Herein, the identifier of the to-be-displayed content may comprise a file name of the to-be-displayed content, or, comprise at least one keyword, a data size, or the like of the to-be-displayed content. The address of the to-be-displayed content is a storage path of the to-be-displayed content in the display device, or, a storage path of the to-be-displayed content in another device and an identifier of the another device, or, a website address. Accordingly, the display device can obtain a part or the whole of the to-be-displayed content according to the content display request.

Optionally, the content display request further comprises: a part or the whole of the to-be-displayed content. Accordingly, the display device can obtain a part or the whole of the to-be-displayed content from the content display request.

In a possible embodiment, the sending, by the request device, a content display request of to-be-displayed content to the display device comprises:

sending, by the request device, the content display request to the display device in response to a detected second signal from the display device.

Optionally, the second signal is a signal based on a second communication technology.

Herein, the second communication technology may be Bluetooth, WiFi, or Zigbee. Further, the second communication technology may be BLE.

Further optionally, the sending, by the request device, a content display request to the display device comprises:

sending, by the request device, the content display request to the display device based on the second communication technology in response to the second signal is detected.

202: Send a display instruction to the display device in response to a first signal is detected, wherein the display instruction is used for instructing the display device to display the to-be-displayed content.

In the embodiment in which the request device sends the content display request in response to the second signal is detected, optionally, the type of the first signal is different from that of the second signal.

Herein, the types being different means that the first signal and the second signal are signals based on different communication technologies, or, one of the first signal and the second signal is a signal based on a certain communication technology and the other one is a signal which is not based on any communication technology.

In an optional embodiment, the first signal is a signal from the display device and based on a first communication technology. Optionally, the sending a display instruction to the display device comprises:

sending, by the request device, the display instruction to the display device based on the first communication technology.

Herein, one possible scenario is described as: the second signal is a signal based on a second communication technology.

Further optionally, if the type of the first signal is different from that of the second signal, the second communication technology is different from the first communication technology. For example, the request device sends the content display request to the display device in response to detecting a signal transmitted by the display device based on a communication technology, and sends the display instruction to the display device in response to detecting a signal transmitted by the display device based on another communication technology.

Herein, optionally, the first communication technology is NFC.

In another optional embodiment, the first signal is a magnetic signal. Generally, a magnetic signal is a signal sent by a magnet. The magnet may be disposed in the display device.

Herein, one possible scenario is described as: the second signal is a signal based on a second communication technology. Further optionally, the sending a display instruction to the display device comprises:

sending, by the request device, the display instruction to the display device based on the second communication technology.

For example, the request device sends the content display request to the display device in response to detecting a signal transmitted by the display device based on a communication technology, and sends the display instruction to the display device in response to detecting a magnetic signal.

In any one of the embodiments or scenarios, optionally, the content display request further comprises: a display type. The display type comprises at least one of the followings: opening, playing, zooming in, and full screen. Accordingly, the display instruction is used for instructing the display device to display the to-be-displayed content according to the display type.

In a possible scenario, the distance between the request device and the display device is a first distance when the request device sends the content display request to the display device. The distance between the request device and the display device is a second distance when the request device detects the first signal. Optionally, the first distance is greater than the second distance.

Specifically, the request device and/or the display device is/are (a) mobile device(s). During the device(s)'s moving process, the distance between the request device and the display device changes. Optionally, the distance is diminishing. Further, if the first distance is greater than the second distance: before a condition for sending a display instruction is met, that is, when the request device does not detect the first signal, the request device has sent a content display request to the display device, the display device obtains a part or the whole of the to-be-displayed content, and when the condition for sending the display instruction is met, the request device sends the display instruction to the display device and the display device can implement rapid displaying on the basis of the obtained part or whole of the to-be-displayed content.

For example, when a mobile phone receives a picture, a smart watch which is connected to the mobile phone and equipped on a wrist of a user informs the user of the message and displays a thumbnail of the picture. Also, the smart watch acts as a request device and broadcasts a content display request to a display device (for example, a PAD) under an instruction of the user or automatically. The PAD receives the content display request so as to obtain the picture. If the user wants to view specific content on the PAD, the user may go to pick up the PAD. During the user's moving process, the distance between the smart watch and the PAD is also continuously diminishing. When the distance between the smart watch and the PAD reaches a certain distance (for example, 0.2 m), the smart watch detects a signal based on NFC sent by the PAD, the smart watch sends a display instruction to the PAD, and the PAD displays the picture. Or, if the user wants to view specific content on the PAD, the user may pick up a controller provided with a magnet to approach the smart watch. During the user's moving process, the distance between the controller and the smart watch is accordingly continuously diminishing. When the distance between the controller and the smart watch reaches a certain distance (for example, 0.2 m), the smart watch detects a magnetic signal sent by the controller and sends a display instruction to the PAD, and the PAD displays the picture.

This embodiment provides a display solution through that the request device sends a content display request of the to-be-displayed content to the display device and sends a display instruction to the display device in response to a detected first signal, wherein the display instruction is used for instructing the display device to display the to-be-displayed content, and provides a user with a convenient display triggering approach through the first signal.

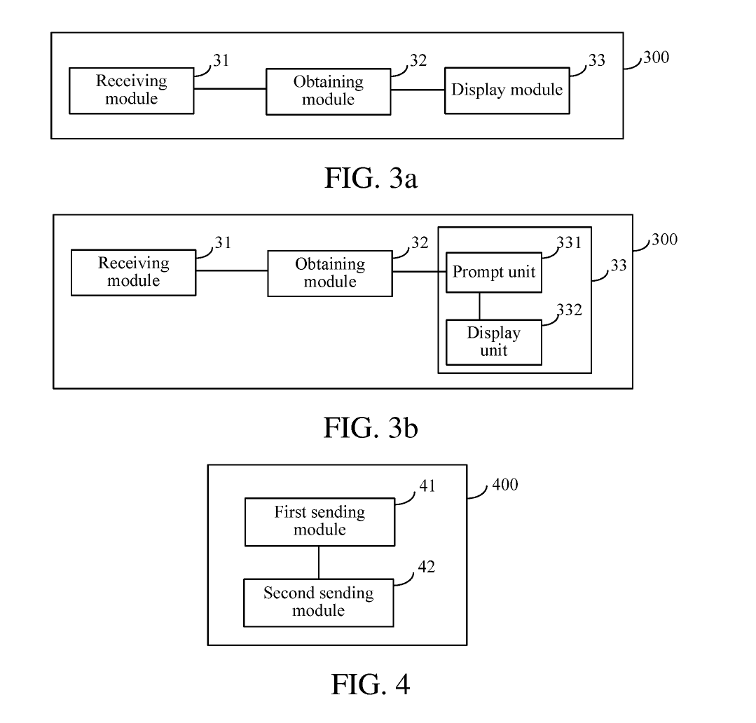

FIG. 3a is a structural diagram of Embodiment 1 of a display device provided in the present application. As shown in FIG. 3a, a display device 300 comprises:

a receiving module 31, configured to receive a content display request from a request device;

an obtaining module 32, configured to obtain to-be-displayed content according to the content display request; and

a display module 33, configured to display the to-be-displayed content in response to a first signal is detected.

Optionally, the content display request comprises: an identifier and/or address of the to-be-displayed content. Herein, the identifier of the to-be-displayed content may comprise a file name of the to-be-displayed content, or, comprise at least one keyword, a data size, or the like of the to-be-displayed content. The address of the to-be-displayed content is a storage path of the to-be-displayed content in the display device, or, a storage path of the to-be-displayed content in another device and an identifier of the another device, or, a website address.

Optionally, the receiving module 31 is further configured to:

receive the content display request from the request device based on a first communication technology.

Herein, the first communication technology may be Bluetooth, WiFi, or Zigbee. Further, the first communication technology may be BLE.

Specifically, the to-be-displayed content comprises but not limited to at least one of the followings: a picture, a video, a text message, and the like.

In an optional embodiment, the obtaining module 32 is further configured to:

obtain a part or the whole of the to-be-displayed content from the display device 300 locally or externally 300 according to the content display request.

For example, if the to-be-displayed content is stored in the display device 300, the content display request may only comprise an identifier of the to-be-displayed content; or, the content display request may only comprise a storage path of the to-be-displayed content in the display device 300; or, the content display request may comprise an identifier of the to-be-displayed content and a storage path of the to-be-displayed content in the display device 300, and accordingly, the obtaining module 32 obtains a part or the whole of the to-be-displayed content locally from the display device 300. If the to-be-displayed content is stored in another device, the content display request may only comprise an identifier of the to-be-displayed content, and accordingly, the obtaining module 32 searches, in a local area network or through a search engine, for and obtains the to-be-displayed content from the another device; or, the content display request may comprise an address of the to-be-displayed content, and accordingly, the obtaining module 32 obtains a part or the whole of the to-be-displayed content from the another device according to the address of the to-be-displayed content.

Generally, if the data size of the to-be-displayed content is small, the obtaining module 32 directly may obtain the whole of the to-be-displayed content. If the data size of the to-be-displayed content is large, the obtaining module 32 may first obtain a part of the to-be-displayed content and further obtain the other part of the to-be-displayed content during a display process of the display module 33.

In another optional embodiment, the content display request further comprises: a part or the whole of the to-be-displayed content.

Optionally, the obtaining module 32 is further configured to:

obtain a part or the whole of the to-be-displayed content from the content display request.

For example, if the content display request comprises the whole of the to-be-displayed content, the obtaining module 32 obtains the whole of the to-be-displayed content from the content display request, or, first obtains a part of the to-be-displayed content from the content display request and then obtains the other part of the to-be-displayed content from the content display request during a display process of the display module 33. If the content display request comprises a part of the to-be-displayed content and an address of the to-be-displayed content, the obtaining module 32 obtains the part of the to-be-displayed content from the content display request and then obtains the other part of the to-be-displayed content according to the address of the to-be-displayed content during a display process of the display module 33.

In an optional embodiment, the display module 33 displays the to-be-displayed content as long as the first signal is detected. That is, detecting a first signal is a unique condition for displaying the to-be-displayed content.

In another optional embodiment, the display module 33 is further configured to:

display the to-be-displayed content according to a display instruction from the request device and based on a second communication technology.

Herein, when the display instruction is obtained by the display device 300 is not limited in this embodiment. Optionally, the receiving module 31 receives the display instruction before the first signal is detected, and accordingly, the display module 33 does not immediately display to-be-displayed content after the receiving module 31 receives the display instruction, but rather displays the to-be-displayed content after the receiving module 31 detects the first signal. Optionally, the receiving module 31 receives the display instruction at the same time when the first signal is detected, and accordingly, the display module 33 displays the to-be-displayed content after the receiving module 31 simultaneously detects the first signal and receives the display instruction. Optionally, the receiving module 31 receives the display instruction after the first signal is detected, and accordingly, the display module 33 does not immediately display to-be-displayed content after the receiving module 31 detects the first signal, but rather that the display module 33 displays the to-be-displayed content after the receiving module 31 receives the display instruction.

In any one of the embodiments, the first signal may be a signal of any type, for example, a signal based on a certain communication technology or a magnetic signal.

Optionally, the first signal is a signal from the request device based on a third communication technology.

Herein, one possible scenario is described as: the third communication technology is different from the first communication technology. For example, the receiving module 31 receives, based on a communication technology, the content display request sent by the request device, and the display module 33 displays the to-be-displayed content in response to the receiving module 31 detects a signal transmitted by the request device and based on another communication technology.

In this scenario, the display module 33 may perform displaying without the display instruction, or may also perform displaying according to the display instruction. The third communication technology may be the same as or different from the second communication technology. The first communication technology may be the same as or different from the second communication technology.

Another possible scenario is described as: the third communication technology is the same as the second communication technology. For example, the display module 33 displays the to-be-displayed content when two conditions, namely, the receiving module 31 receives, based on a communication technology, a display instruction sent by the request device and the receiving module 31 detects a signal transmitted by the request device and based on the communication technology, are both met. In this scenario, the first communication technology may be the same as or different from the second communication technology.

Another possible scenario is described as: the third communication technology is different from the second communication technology. For example, the display module 33 displays the to-be-displayed content when two conditions, namely, the receiving module 31 receives, based on a communication technology, a display instruction sent by the request device and the receiving module 31 detects a signal transmitted by the request device and based on another communication technology, are both met. In this scenario, the first communication technology may be the same as or different from the second communication technology. The first communication technology may be the same as or different from the third communication technology.

Optionally, the third communication technology is NFC.

Optionally, the first signal is a magnetic signal. Generally, a magnetic signal is a signal sent by a magnet. The magnet may be disposed in the request device or another device.

Herein, one possible scenario is described as: the second communication technology is the same as the first communication technology. For example, the receiving module 31 receives, based on a communication technology, a content display request sent by the request device, and the display module 33 displays the to-be-displayed content in a case where two conditions, namely, the receiving module 31 detects a magnetic signal sent by the request device or another device and receives, based on the communication technology, a display instruction sent by the request device, are both met.

Another possible scenario is described as: the second communication technology is different from the first communication technology. For example, the receiving module 31 receives, based on a communication technology, a content display request sent by the request device, and the display module 33 displays the to-be-displayed content in a case where two conditions, namely, the receiving module 31 detects a magnetic signal sent by the request device or another device and receives, based on another communication technology, a display instruction sent by the request device, are both met.

In any one of the embodiments or scenarios, optionally, the user may further be requested for a confirmation before the displaying. Specifically, as shown in FIG. 3b, the display module 33 comprises:

a prompt unit 331, configured to prompt a user in response to a first signal is detected; and

a display unit 332, configured to display the to-be-displayed content according to a display confirmation of the user.

Herein, there are multiple methods for prompting the user by the prompt unit 331. For example, the prompt unit 331 presents a window on a display interface of the display device 300, a user is requested to determine whether to perform displaying, and when the user clicks a “confirm” button in the window, the display unit 332 receives a display confirmation from the user and then performs displaying.

Optionally, if the display unit 332 does not receive a display confirmation from the user after the user is prompted by the prompt unit 331, the to-be-displayed content is not displayed.

Optionally, in an embodiment in which a display instruction is needed, the prompt unit 331 prompts a user and the display unit 332 displays the to-be-displayed content according to a display confirmation from the user when two conditions, namely, the receiving module 31 receives the display instruction and detects the first signal, are both met.

In an optional embodiment, the content display request further comprises: a display type.

The display type comprises at least one of the followings: opening, playing, zooming in, and full screen.

The display module 33 is further configured to: display the to-be-displayed content in response to the detected first signal.

Specifically, the corresponding display type may be slightly disparate for different to-be-displayed content. For example, when the to-be-displayed content is a picture: if the display type is opening, the display module 33 selects software capable of opening the picture to open the picture; if the display type is zooming in, the display module 33 zooms in the picture according to a preset multiple on the basis of the opening the picture; and if the display type is full screen, the display module 33 displays the picture in full screen on the basis of the opening the picture. When the to-be-displayed content is a video: if the display type is opening, the display module 33 selects software capable of opening the video to open the video, but does not play it, and at this time, what is displayed may be an image of the video; if the display type is playing, the display module 33 selects software capable of playing the video to play the video; and if the display type comprises playing and full screen, the display module 33 selects software capable of playing the video to play the video in full screen.

In any one of the embodiments or scenarios, optionally, the display device 300 further comprises:

a feedback module, configured to return a display success message to the request device after the to-be-displayed content is displayed on the display module 33.

In a possible scenario, the distance between the display device 300 and the request device is a first distance when the receiving module 31 receives the content display request from the request device. The distance between the display device 300 and the request device is a second distance when the display device 300 detects the first signal. Optionally, the first distance is greater than the second distance.

Specifically, the display device 300 and/or the request device is/are (a) mobile device(s). During the device(s)'s moving process, the distance between the display device 300 and the request device changes. Optionally, the distance is diminishing. Further, if the first distance is greater than the second distance: before a display condition is met, that is, when the first signal is not detected, the receiving module 31 has received a content display request and the obtaining module 32 has obtained a part or the whole of the to-be-displayed content, and when the display condition is met, the display module 33 can implement rapid displaying on the basis of the obtained part or whole of the to-be-displayed content.

For example, when a mobile phone receives a picture, a smart watch which is connected to the mobile phone and equipped on a wrist of a user informs the user of the message and displays a thumbnail of the picture. Also, the smart watch acts as a request device and broadcasts a content display request through a BLE link under an instruction of the user or automatically. Multiple display devices, such as a mobile phone, a PAD, and a smart television set, within a broadcasting range of the smart watch all receive the content display request so as to obtain the picture. If the user wants to view specific content on the PAD, the user may go to pick up the PAD. During the user's moving process, the distance between the smart watch and the PAD is also continuously diminishing. When the distance between the smart watch and the PAD reaches a certain distance (for example, 0.2 m), the PAD detects a signal based on NFC sent by the smart watch and the PAD displays the picture. Or, if the user wants to view specific content on the PAD, the user may pick up a controller provided with a magnet to approach the PAD. During the user's moving process, the distance between the controller and the PAD is accordingly continuously diminishing. When the distance between the controller and the PAD reaches a certain distance (for example, 0.2 m), the PAD detects a magnetic signal sent by the controller, and the PAD displays the picture.

This embodiment provides a display solution through that the display device receives a content display request from the request device, obtains to-be-displayed content according to the content display request, and displays the to-be-displayed content in response to a detected first signal, and provides a user with choices and a convenient display triggering approach of the display device through the first signal.

FIG. 4 is a structural diagram of Embodiment 1 of a request device provided in the present application. As shown in FIG. 4, a request device 400 comprises:

a first sending module 41, configured to send a content display request of to-be-displayed content to a display device; and

a second sending module 42, configured to send a display instruction to the display device in response to a first signal is detected, wherein the display instruction is used for instructing the display device to display the to-be-displayed content.

Specifically, the to-be-displayed content comprises but not limited to at least one of the followings: a picture, a video, a text message, and the like.

Optionally, the content display request comprises: an identifier and/or address of the to-be-displayed content. Herein, the identifier of the to-be-displayed content may comprises a file name of the to-be-displayed content, or, comprise at least one keyword, a data size, or the like of the to-be-displayed content. The address of the to-be-displayed content is a storage path of the to-be-displayed content in the display device, or, a storage path of the to-be-displayed content in another device and an identifier of the another device, or, a website address. Accordingly, the display device can obtain a part or the whole of the to-be-displayed content according to the content display request.

Optionally, the content display request further comprises: a part or the whole of the to-be-displayed content. Accordingly, the display device can obtain a part or the whole of the to-be-displayed content from the content display request.

In a possible embodiment, the first sending module 41 is further configured to:

send the content display request to the display device in response to a detected second signal from the display device.

Optionally, the second signal is a signal based on a second communication technology.

Herein, the second communication technology may be Bluetooth, WiFi, or Zigbee. Further, the second communication technology may be BLE.

Further optionally, the first sending module 41 is further configured to:

send a content display request to the display device based on the second communication technology in response to the second signal is detected.

In the embodiment in which the request device sends the content display request in response to the second signal is detected, optionally, the type of the first signal is different from that of the second signal.

Herein, the types being different means that the first signal and the second signal are signals based on different communication technologies, or, one of the first signal and the second signal is a signal based on a certain communication technology and the other one is a signal which is not based on any communication technology.

In an optional embodiment, the first signal is a signal from the display device and based on a first communication technology. Optionally, the second sending module 42 is further configured to: send a display instruction to the display device based on the first communication technology in response to the detected first signal.

Herein, one possible scenario is described as: the second signal is a signal based on a second communication technology.

Further optionally, if the type of the first signal is different from that of the second signal, the second communication technology is different from the first communication technology. For example, the first sending module 41 sends the content display request to the display device in response to detecting a signal transmitted by the display device based on a communication technology, and the second sending module 42 sends the display instruction to the display device in response to detecting a signal transmitted by the display device based on another communication technology.

Herein, optionally, the first communication technology is NFC.

In another optional embodiment, the first signal is a magnetic signal. Generally, a magnetic signal is a signal sent by a magnet. The magnet may be disposed in the display device.

Herein, one possible scenario is described as: the second signal is a signal based on a second communication technology. Further optionally, the second sending module 42 is further configured to: send a display instruction to the display device based on the second communication technology in response to the detected first signal.

For example, the first sending module 41 sends the content display request to the display device in response to detecting a signal transmitted by the display device based on a communication technology and the second sending module 42 sends the display instruction to the display device in response to detecting a magnetic signal.

In any one of the embodiments or scenarios, optionally, the content display request further comprises: a display type. The display type comprises at least one of the followings: opening, playing, zooming in, and full screen. Accordingly, the display instruction is used for instructing the display device to display the to-be-displayed content according to the display type.

In a possible scenario, the distance between the request device 400 and the display device is a first distance when the first sending module 41 sends the content display request to the display device. The distance between the request device 400 and the display device is a second distance when the second sending module 42 detects the first signal. Optionally, the first distance is greater than the second distance.

Specifically, the request device 400 and/or the display device is/are (a) mobile device(s). During the device(s)'s moving process, the distance between the request device 400 and the display device changes. Optionally, the distance is diminishing. Further, if the first distance is greater than the second distance: before a condition for sending a display instruction is met, that is, when the second sending module 42 does not detect the first signal, the first sending module 41 has sent a content display request to the display device, the display device obtains a part or the whole of the to-be-displayed content, and when the condition for sending the display instruction is met, the second sending module 42 sends the display instruction to the display device and the display device can implement rapid displaying on the basis of the obtained part or whole of the to-be-displayed content.

For example, when a mobile phone receives a picture, a smart watch which is connected to the mobile phone and equipped on a wrist of a user informs the user of the message and displays a thumbnail of the picture. Also, the smart watch acts as a request device and broadcasts a content display request to a display device (for example, a PAD) under an instruction of the user or automatically. The PAD receives the content display request so as to obtain the picture. If the user wants to view specific content on the PAD, the user may go to pick up the PAD. During the user's moving process, the distance between the smart watch and the PAD is also continuously diminishing. When the distance between the smart watch and the PAD reaches a certain distance (for example, 0.2 m), the smart watch detects a signal based on NFC sent by the PAD, the smart watch sends a display instruction to the PAD, and the PAD displays the picture. Or, if the user wants to view specific content on the PAD, the user may pick up a controller provided with a magnet to approach the smart watch. During the user's moving process, the distance between the controller and the smart watch is accordingly continuously diminishing. When the distance between the controller and the smart watch reaches a certain distance (for example, 0.2 m), the smart watch detects a magnetic signal sent by the controller and sends a display instruction to the PAD and the PAD displays the picture.

This embodiment provides a display solution through that the request device sends a content display request of the to-be-displayed content to the display device and sends a display instruction to the display device in response to a detected first signal, wherein the display instruction is used for instructing the display device to display the to-be-displayed content, and provides a user with a convenient display triggering approach through the first signal.

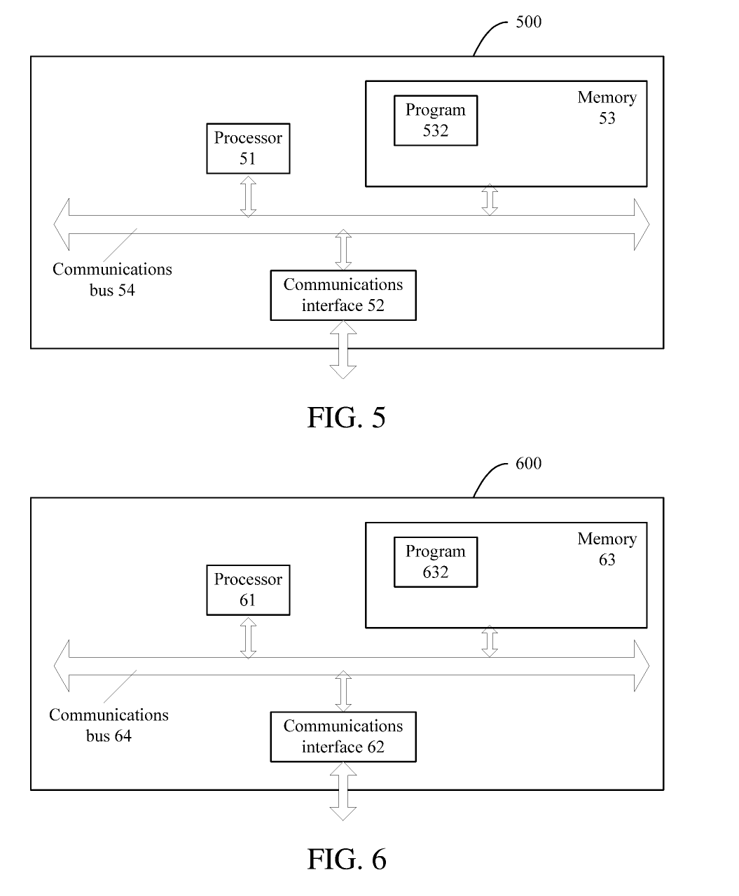

FIG. 5 is a structural diagram of Embodiment 2 of a display device provided in the present application. As shown in FIG. 5, a display device 500 comprises:

a processor 51, a communication interface 52, a memory 53, and a communication bus 54, wherein:

the processor 51, the communication interface 52, and the memory 53 complete mutual communication with each other through the communication bus 54.

the communication interface 52 is configured to perform communication with an external device such as a request device; and

the processor 51 is configured to execute a program 532 and specifically may execute a relevant step in Embodiment 1 of the method.

Specifically, the program 532 may comprise a program code. The program code comprises a computer operating instruction.

The processor 51 may be a central processing unit CPU or an Application Specific Integrated Circuit (ASIC), or be configured to be one or more integrated circuits of Embodiment 1 of the implementation method.

The memory 53 is configured to store the program 532. The memory 53 may comprise a high-speed RAM memory and may also further comprise a non-volatile memory, for example, at least one disk memory. The program 532 specifically may be configured to cause the display device 500 to execute the following steps:

receiving a content display request from a request device;

obtaining to-be-displayed content according to the content display request; and

displaying the to-be-displayed content in response to a first signal is detected.

Specific implementations of all steps in the program 532 may be referred to in the corresponding description in the corresponding steps and units in Embodiment 1 of the method, which is not described again in detail herein. It can be clearly understood by persons skilled in the art that, for the purpose of convenient and brief description, for a detailed working process of the described devices and modules, reference may be made to the corresponding process in Embodiment 1 of the aforementioned method, and the details will not be described herein again.

FIG. 6 is a structural diagram of Embodiment 2 of a request device provided in the present application. As shown in FIG. 6, a request device 600 comprises:

a processor 61, a communication interface 62, a memory 63, and a communication bus 64, wherein:

The processor 61, the communication interface 62, and the memory 63 complete mutual communication with each other through the communication bus 64.

The communication interface 62 is configured to perform communication with an external device such as a display device.

The processor 61 is configured to execute a program 632 and specifically may execute a relevant step in Embodiment 2 of the method.

Specifically, the program 632 may comprise a program code. The program code comprises a computer operating instruction.

The processor 61 may be a central processing unit CPU or an ASIC, or be configured to be one or more integrated circuits of Embodiment 2 of the implementation method.

The memory 63 is configured to store the program 632. The memory 63 may comprise a high-speed RAM memory and may also further comprise a non-volatile memory, for example, at least one disk memory. The program 632 specifically may be configured to cause the request device 600 to execute the following steps:

sending a content display request of to-be-displayed content to a display device; and

sending a display instruction to the display device in response to a first signal is detected, wherein the display instruction is used for instructing the display device to display the to-be-displayed content.

Specific implementations of all steps in the program 632 may be referred to in the corresponding description in the corresponding steps and units in Embodiment 2 of the content displaying method, and the details will not be described herein. It can be clearly understood by persons skilled in the art that, for the purpose of convenient and brief description, for a detailed working process of the described devices and modules, reference may be made to the corresponding process in Embodiment 2 of the aforementioned content displaying method, and the details will not be described herein again.

Persons of ordinary skill in the art should appreciate that, in combination with the examples described in the embodiments herein, units and method steps can be implemented by electronic hardware, or a combination of computer software and electronic hardware. Whether the functions are executed by hardware or software depends on specific applications and design constraint conditions of the technical solutions. Persons skilled in the art can use different methods to implement the described functions for every specific application, but it should not be considered that this implementation goes beyond the scope of the present invention.

When being implemented in the form of a software functional unit and sold or used as a separate product, the functions may be stored in a computer-readable storage medium. Based on such understanding, the technical solutions of the present invention essentially, or the part contributing to the prior art, or part of the technical solutions may be implemented in a form of a software product. The computer software product is stored in a storage medium, and comprises several instructions for instructing a computer device (which may be a personal computer, a server, a network device, and the like) to execute all or part of the steps of the method described in each of the embodiments of the present invention. The aforementioned storage medium comprises: any medium that can store program codes, such as a USB disk, a removable hard disk, a read-only memory (ROM), a random access memory (RAM), a magnetic disk, or an optical disc.

The aforementioned description of the embodiments are merely provided for describing the present application, but not intended to limit the present application. Persons of ordinary skills in the art can also make many variations and changes without departing from the sprint and the scope of protection of the present application. Therefore, all the equivalent technical solutions also fall within the scope of the present application, and the scope of protection of the patent of the present application is limited by the claims.

1. A method, comprising:
receiving, by a display device, a content display request from a request device;
obtaining to-be-displayed content according to the content display request; and
displaying the to-be-displayed content in response to a first signal being detected.

2. The method of claim 1, wherein the receiving the content display request from the request device comprises:
receiving, by the display device, the content display request from the request device based on a first communication technology.

3. The method of claim 2, wherein the first communication technology is Bluetooth, WiFi, or Zigbee.

4. The method of claim 2, wherein the displaying the to-be-displayed content comprises:
displaying the to-be-displayed content according to a display instruction from the request device and based on a second communication technology.

5. The method of claim 1, wherein the first signal is a signal from the request device and based on a third communication technology.

6. The method of claim 5, wherein the third communication technology is different from the first communication technology.

7. The method of claim 5, wherein the third communication technology is a same communication technology as the second communication technology.

8. The method of claim 5, wherein the third communication technology is near field communication (NFC).

9. The method of claim 1, wherein the first signal is a magnetic signal.

10. The method of claim 4, wherein the first signal is a magnetic signal, and the second communication technology is a same communication technology as the first communication technology.

11. The method of claim 1, wherein the content display request comprises an identifier an address of the to-be-displayed content.

12. The method of claim 11, wherein the content display request further comprises a part or all of the to-be-displayed content.

13. The method of claim 12, wherein the obtaining to-be-displayed content according to the content display request comprises:
obtaining a part or all of the to-be-displayed content from the content display request.

14. The method of claim 1, wherein the obtaining to-be-displayed content according to the content display request comprises:
obtaining a part or all of the to-be-displayed content from the display device locally or externally according to the content display request.

15. The method of claim 1, wherein the displaying the to-be-displayed content in response to the first signal being detected comprises:
prompting a user device in response to the first signal being detected; and
displaying the to-be-displayed content according to a display confirmation of the user device.

16. A method, comprising:
sending, by a request device, a content display request of to-be-displayed content to a display device; and
sending a display instruction to the display device in response to detecting a first signal, wherein the display instruction is used to instruct the display device to display the to-be-displayed content.

17. The method of claim 16, wherein the sending the content display request of to-be-displayed content to the display device comprises:
sending, by the request device, the content display request to the display device in response to detecting a second signal from the display device.

18. The method of claim 17, wherein the second signal is a signal based on a second communication technology.

19. The method of claim 18, wherein the sending, by the request device, the content display request to the display device comprises:
sending, by the request device, the content display request to the display device based on the second communication technology.

20. The method of claim 18, wherein the second communication technology is Bluetooth, WiFi, or Zigbee.

21. The method of claim 17, wherein the type of the first signal is different from that of the second signal.

22. The method of claim 16, wherein the first signal is a signal from the display device and based on a first communication technology.

23. The method of claim 18, wherein the first signal is a signal from the display device and based on a first communication technology, and the second communication technology is different from the first communication technology.

24. The method of claim 22, wherein the sending the display instruction to the display device comprises:
sending, by the request device, the display instruction to the display device based on the first communication technology.

25. The method of claim 22, wherein the first communication technology is near field communication (NFC).

26. The method of claim 16, wherein the first signal is a magnetic signal.

27. The method of claim 18, wherein the first signal is a magnetic signal, and the sending the display instruction to the display device comprises:
sending, by the request device, the display instruction to the display device based on the second communication technology.

28. The method of claim 16, wherein the content display request comprises an identifier or an address of the to-be-displayed content.

29. The method of claim 28, wherein the content display request further comprises at least a part of the to-be-displayed content.

30. A display device, comprising:
a processor, coupled to a memory, that executes or facilitates execution of executable modules, comprising:
a receiving module configured to receive a content display request from a request device;
an obtaining module configured to obtain to-be-displayed content according to the content display request; and
a display module configured to display the to-be-displayed content in response to a first signal being detected.

31. The display device of claim 30, wherein the receiving module is further configured to:
receive the content display request from the request device based on a first communication technology.

32. The display device of claim 31, wherein the first communication technology is Bluetooth, WiFi, or Zigbee.

33. The display device of claim 31, wherein the display module is further configured to:
display the to-be-displayed content according to a display instruction from the request device and based on a second communication technology.

34. The display device of claim 30, wherein the first signal is a signal from the request device and based on a third communication technology.

35. The display device of claim 34, wherein the third communication technology is different from the first communication technology.

36. The display device of claim 34, wherein the third communication technology is a same communication technology as the second communication technology.

37. The display device of claim 34, wherein the third communication technology is near field communication (NFC).

38. The display device of claim 30, wherein the first signal is a magnetic signal.

39. The display device of claim 33, wherein the first signal is a magnetic signal and the second communication technology is a same communication technology as the first communication technology.

40. The display device of claim 30, wherein the content display request comprises: an identifier or an address of the to-be-displayed content.

41. The display device of claim 40, wherein the content display request further comprises a part or all of the to-be-displayed content.

42. The display device of claim 41, wherein the obtaining module is further configured to:
obtain a part or all of the to-be-displayed content from the content display request.

43. The display device of claim 30, wherein the obtaining module is further configured to obtain at least a part of the to-be-displayed content from the display device locally or externally according to the content display request.

44. The display device of claim 30, wherein the display module comprises:
a prompt unit configured to prompt a user in response to detecting the first signal; and
a display unit configured to display the to-be-displayed content according to a display confirmation of the user.

45. A request device, comprising:
a processor, coupled to a memory, that executes or facilitates execution of executable modules, comprising:
a first sending module configured to send a content display request of to-be-displayed content to a display device; and
a second sending module configured to send a display instruction to the display device in response to detecting a first signal, wherein the display instruction is used to instruct the display device to display the to-be-displayed content.

46. The request device of claim 45, wherein the first sending module is further configured to:
send the content display request to the display device in response to detecting a second signal from the display device.

47. The request device of claim 46, wherein the second signal is a signal based on a second communication technology.

48. The request device of claim 47, wherein the first sending module is further configured to:
send the content display request to the display device based on the second communication technology.

49. The request device of claim 47, wherein the second communication technology is Bluetooth, WiFi, or Zigbee.

50. The request device of claim 46, wherein the type of the first signal is different from that of the second signal.

51. The request device of claim 45, wherein the first signal is a signal from the display device and based on a first communication technology.

52. The request device of claim 47, wherein the first signal is a signal from the display device and based on a first communication technology, and the second communication technology is different from the first communication technology.

53. The request device of claim 51, wherein the second sending module is further configured to send a display instruction to the display device based on the first communication technology in response to the first signal being detected.

54. The request device of claim 51, wherein the first communication technology is near field communication (NFC).

55. The request device of claim 45, wherein the first signal is a magnetic signal.

56. The request device of claim 47, wherein the first signal is a magnetic signal, and the second sending module is further configured to send a display instruction to the display device based on the second communication technology in response to the first signal being detected.

57. The request device of claim 45, wherein the content display request comprises: an identifier or an address of the to-be-displayed content.

58. The request device of claim 57, wherein the content display request further comprises at least a part of the to-be-displayed content.

59. A computer readable storage device comprising executable instructions that, in response to execution, cause a display device comprising a processor to perform operations, comprising:
receiving a content display request from a request device;
obtaining to-be-displayed content according to the content display request; and
displaying the to-be-displayed content in response to a first signal being detected.

60. A computer readable storage device comprising executable instructions that, in response to execution, cause a request device comprising a processor to perform operations, comprising:
sending a content display request of to-be-displayed content to a display device; and
sending a display instruction to the display device in response to a first signal is detected, wherein the display instruction is used to instruct the display device to display the to-be-displayed content.
